(19) United States
(12) Patent Application Publication
(10) Pub. No.: US 2003/0103219 A1
(43) Pub. Date: Jun. 5, 2003

(54) Method and apparatus for creating personalized balloons

(76) Inventor: Jennifer C. Waskow, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/005,269

(22) Filed: Dec. 3, 2001

(51) Int. Cl. B41J 1/00; G06F 15/00

(52) U.S. Cl. 358/1.1

(57) ABSTRACT

A method and apparatus for creating personalized balloons. A printable, e.g., foil, balloon is disposed on a frame and sent though an inkjet printer. The inkjet printer prints a message, text, graphics, or combination text and graphics, onto the balloon. The foil balloon may be a Mylar™ balloon with a thickness small enough to pass through a standard inkjet printer.

### FIELD OF THE INVENTION

This invention relates to a method and apparatus for personalizing balloons, and more particularly to a method and apparatus for creating personalized foil, polyester, or Mylar™ balloons.

### BACKGROUND OF THE INVENTION

Inflatable balloon printing devices are know for applying color drawings and letterings on the external surface of foil balloons. Foil balloons are usually designed out of a polyester film such as Mylar™. The application of drawings and lettering is often done for entertainment and advertising purposes. The most common method of applying drawings and letters to foil balloons is by a silkscreen printing process. According to conventional practice, the balloon is inflated, and biased against an ink permeable silk screen until the balloon is yieldingly deformed against the screen so as to obtain a temporarily flat balloon surface in contact with the silk screen. Color is then applied to this flat balloon surface through the silk screen, with a wiper that runs horizontally along the screen. The balloon is then removed from the silk screen, and assumes its original shape, with the desired design imprinted on the balloon surface. Several colors can be applied in the same manner by moving the balloon through sequential color printing stations. For example, a balloon may progress through four colored printing stations, one for red, yellow, blue, and black.

Balloon printing apparatuses have been devised over the years which include a number of sequential stations, namely a station for installing the balloon on the apparatus, an inflating station for inflating the balloon, several color printing stations for applying the color image on the balloon surface, a drying station for speeding the drying of the colored ink on the balloon, and a removal station for removing the balloon from the apparatus, and, possibly, simultaneously removing the air from the inflated balloon.

An important problem associated with the conventional apparatuses as described above is that they may allow, in their sequential color printing stations, the different colors to become slightly offset relative to one another, thus blurring the image on the balloon. Indeed, a slight accidental displacement of the balloon, due to air currents or the acceleration and deceleration of sudden stepwise movements of the balloon from one station to the other, may cause a difference in the position of the balloon during printing relative to a correctly registered position, resulting in the color image of that station being printed thereon at an offset position. The image printed on the balloon may consequently be undesirably blurred and unclear due to poor color registration. This is known as the shadow effect.

In addition, the specialized silk-screen printing apparatus is quite expensive to purchase, maintain, and operate. The conventional process is also very time consuming and labor intensive.

Consequently, there remains a need for fast, inexpensive, and easy to use methods and devices for printing custom images and designs on printable balloons.

### SUMMARY OF THE INVENTION

The present invention provides a balloon printing apparatus including: a foil balloon disposed on a frame; and an inkjet printer receptive of the foil balloon for printing a custom image or design on the foil balloon.

According to one aspect of the invention, the foil balloon includes a polyester film to enhance the longevity of the inflated baloon. The polyester film may include Mylar™.

In some embodiments, the Mylar™ is no thicker than twenty pound bond paper to facilitate ease in passing the balloon through a standard inkjet printer.

According to one aspect of the invention, the inkjet printer is a color inkjet printer. The color inkjet printer may include a straight path of travel for the frame and foil balloon to pass through, or the printer may include a torturous path for the frame and foil balloon to pass through.

According to one aspect of the invention, the frame is paper. According to another aspect of the invention the frame comprises cardstock, plastic, vinyl, or a transparency.

According to one aspect of the invention, the design or image printed comprises letters or text.

The present invention also provides a method of producing a foil balloon with a custom design or image thereon, including the step of passing the foil balloon through an inkjet printer. According to this method the foil balloon may be contained in a frame. The inkjet printer may be a high-speed printer with a straight path to feed the foil balloon. The method may also include the step of inflating the balloon.

According to one aspect of the method disclosed, the inkjet printer is a standard, general use printer. According to another aspect of the method disclosed, the inkjet printer may be an extra-wide printer to more readily accommodate large balloons.

The present invention also provides a method of personalizing a foil balloon including the steps of: loading at least one foil balloon into a inkjet printer; sending a personalized design to the printer; and printing the personalized design onto the at least one foil balloon as the foil balloon passes through the inkjet printer.

According to the method, the foil balloon may be arranged on a frame to facilitate loading into the inkjet printer. The frame may include paper, cardstock, vinyl, or plastic, and the foil balloon may be Mylar™.

In some implementations of the method, the inkjet printer includes a straight path for the foil balloon to travel.

According to one aspect of the method, the personalized design comprises text, graphics, or a combination of text and graphics.

Additional advantages and novel features of the invention will be set forth in the description which follows or may be learned by those skilled in the art through reading these materials or practicing the invention. The advantages of the invention may be achieved through the means recited in the attached claims.

### BRIEF DESCRIPTION OF THE DRAWINGS

The foregoing and other features and aspects of the invention will become further apparent upon reading the following detailed description and upon reference to the drawings in which:

FIG. 1 is a general view of the balloon printing apparatus according to one aspect of the present invention.

FIG. 2 is side view of a high-speed inkjet printer in accordance with one aspect of the present invention.

FIG. 3 is a front view of an extra-wide printer in accordance with one aspect of the present invention.

FIG. 4 is a front view of a design created on a computer for imprinting on a balloon according to one aspect of the present invention.

FIG. 5 is a top view of a foil balloon and frame according to one embodiment of the present invention.

FIG. 6 is a front view of balloons created according to one method of the present invention.

FIG. 7 is a front view of a balloon being inflated according to one method of the present invention.

Throughout the drawings, identical elements are designated by identical reference numbers.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE PREFERRED EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, that will vary from one implementation to another. Moreover, it will be appreciated that such a development effort might be complex and time-consuming, but would nevertheless be a routine undertaking for those of ordinary skill in the art having the benefit of this disclosure.

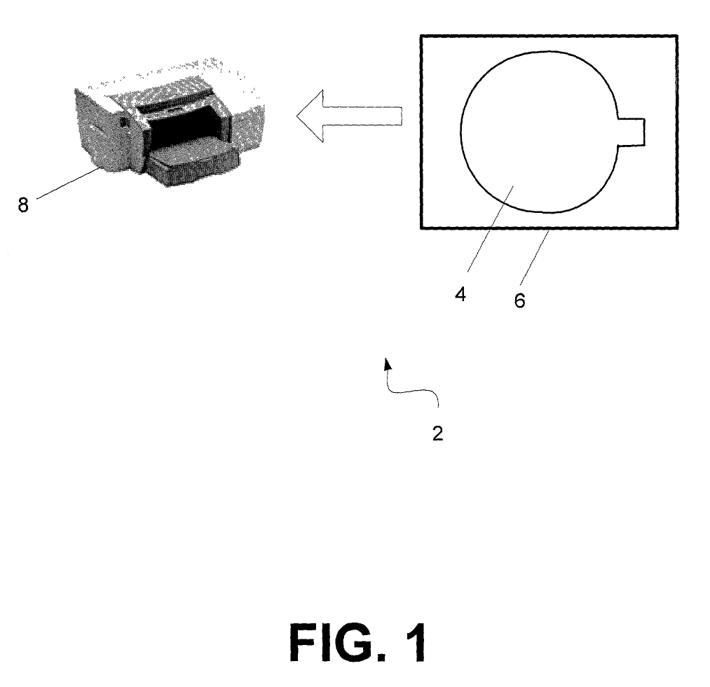

Turning now to the drawings, and in particular to FIG. 1, a customized balloon printing apparatus (2) in accordance with one embodiment of the present invention is disclosed. Balloon printing apparatus (2) makes use of a foil or other printable balloon (4). Foil balloons may include polyester films to increase the longevity of the inflated balloon. Mylar™ is often used in such balloons (4).

The balloon (4) may be disposed on a frame (6). The frame (6) facilitates feeding the balloon (4) into and through an inkjet printer (8). Frame (6) may be constructed from, for example, paper, photo paper, cardstock, plastic, vinyl, a transparency, or the like. In one embodiment, the balloon (4), including any seams thereof, is no thicker than twenty-pound bond paper to ensure that it may pass the inkjet printer (8) without difficulty. However, it will be understood by those of skill in the art with the benefit of this disclosure that any thickness of balloon (4) may be used as long as the thickness is less than that recommended by the printer manufacturer for use with a particular printer (e.g., 8).

The balloon (4) may, in some embodiments, be attached to the frame (6) by an adhesive such as a microsphere type adhesive (used on Post-it™ notes), a rubber cement, or other adhesive that allows easy attachment and detachment of the balloon (4) on the frame (6).

The frame (6) may be sized to enable easy feeding of frame (6) through a variety of printers which having the balloon (4) disposed thereon. For example, the frame (6) may be one of the various standard sizes of paper routinely handled by inkjet printers, e.g., letter size (8.5×11 inches), legal size, A4 size, or 11×17 inches=, or other sizes as necessary.

Alternatively, larger inkjet printers to accommodate larger balloons are within the scope of the present invention. For example, for larger applications, the frame (6) may be five feet wide. Inkjet printers large enough to accommodate such a frame are commercial available. Thus, the frame (6) may be sized to facilitate introduction of the printable balloon (4) into any available inkjet printer.

According to the embodiment shown in FIG. 1, Frame (6) is sized for insertion into a standard inkjet printer (8). Standard inkjet printers are available, for example, from Hewlett-Packard™, Lexmark™, Epson™, Canon™, ColorSpan™, Kodak™ and other sources. Inkjet printers print an image by applying small droplets of ink to a print medium, which, according the present invention, is a printable, e.g., a foil, balloon. The standard inkjet printer (8) may be a color printer or a black and white printer.

The use of a standard inkjet printer (8) to print on the balloon (4) advantageously allows customized balloon printing at very low cost and at almost any location. There is no need for specialized printing equipment as required heretofore.

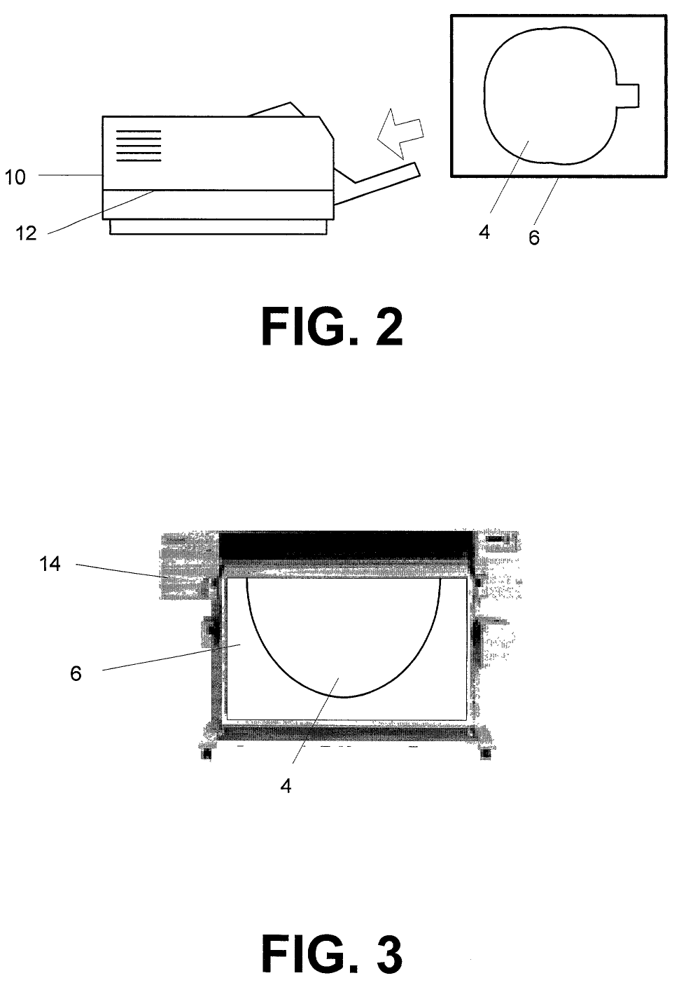

In some embodiments of the present invention, the standard inkjet printer (8) may be replaced by a high-speed inkjet printer (10) for use in printing balloons (4) in high volume as shown in FIG. 2. In such an embodiment, a high-speed inkjet printer (10) may simply have an increased printing rate over standard inkjet printers. Additionally or alternatively, the high-speed printer (10) may include a straight-through printing path (12) for the frame (6) and the balloon (4) carried by the frame in order to facilitate faster throughput. If the frame (6) and balloon (4) do not need to negotiate any twists or turns, which are common in the print medium transport path of inkjet printers, then it is possible to output printed balloons more quickly and with less possibility of a jam in the transport path of the printer (10).

In addition, as indicated above, the inkjet printer used to implement the present invention may be a printer (14) of extra width, as shown in FIG. 3, to print customized balloons of larger sizes. Extra width printers (14) are commercially available and are capable of, for example, accepting print media such as a printable balloon (4) with or without a frame (6), of up to sixty inches in width, and unlimited lengths (continuous feed). FIG. 3 illustrates a frame (6) and printable balloon (4) emerging from an extra width printer (14). An extra width printer (14) may also be a high-speed printer, but this is not necessarily so. Extra width printers (14) are available, for example, from Hewlett-Packard™, ColorSpan™, and other sources.

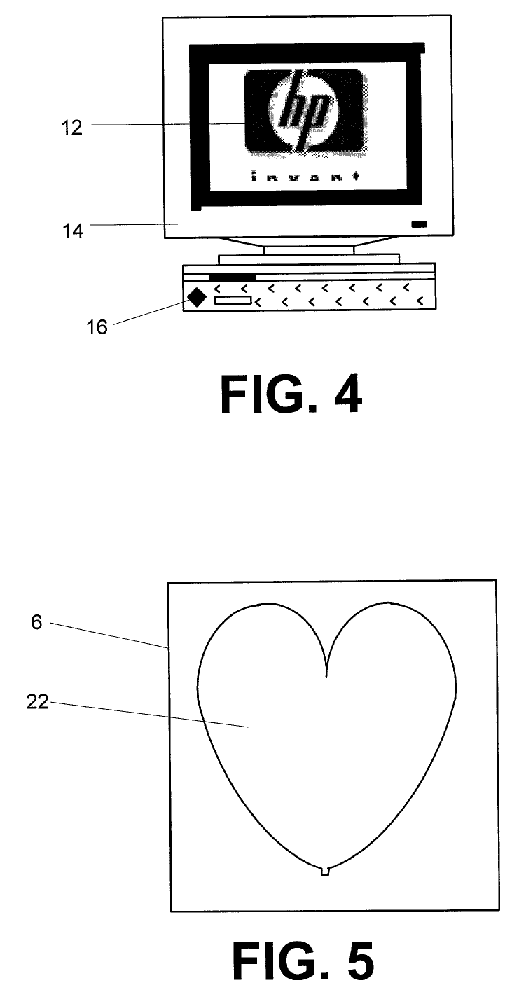

Inkjet printers, such as the standard printer (8) in FIG. 1, the high-speed printer (10) in FIG. 2 and the extra-width printer (14) in FIG. 3, receive electronic data from a host computer or other source that is translated into the image to be printed on the target balloon. FIG. 4 illustrates an exemplary host computer (16) which may be connected, directly or through a network, to a printer that is used to print customized balloon. As shown in FIG. 4, the balloon printer (e.g., 8; FIG. 1) may receive a logo (12) or other personalized design from the host computer (16). In FIG. 4, an exemplary logo is illustrated on the monitor (14) of computer (16). This logo (12) is then transmitted as electronic data to the balloon printer which data is used by the printer to print the desired logo on the target balloon.

The illustration of FIG. 4 is merely an example. As will be understood, the image (e.g., 12) provided by the host computer (16) need not be a logo, but can be any image or design. The image or design for printing onto a balloon according to the present invention may include, but is not limited to: text, letters, graphics, advertisements, figures, any combination thereof, or any other design a user desires to imprint onto balloon. The image to be printed on a target balloon is limited only by the normal printing capabilities of the inkjet printer being used or the software package used to design the image. Any available software package may be used to create a customized design for use with the present invention.

A printable balloon, according to the present invention, may include any variety of shapes and sizes. This includes the standard, generally oval-shaped balloon (4) shown in FIG. 1, or the heart-shaped balloon (22) shown in FIG. 5 disposed on a frame (6). Those of skill in the art having the benefit of this disclosure will understand that the shape of a printable balloon (4) may include circles, squares, hearts, stars, diamonds, or any other regular or irregular shape. Balloons are now even shaped like cartoon characters or action figures. The present invention places no limitations on the shape or size of the balloon being printed, only as such parameters are constrained by the printer being used.

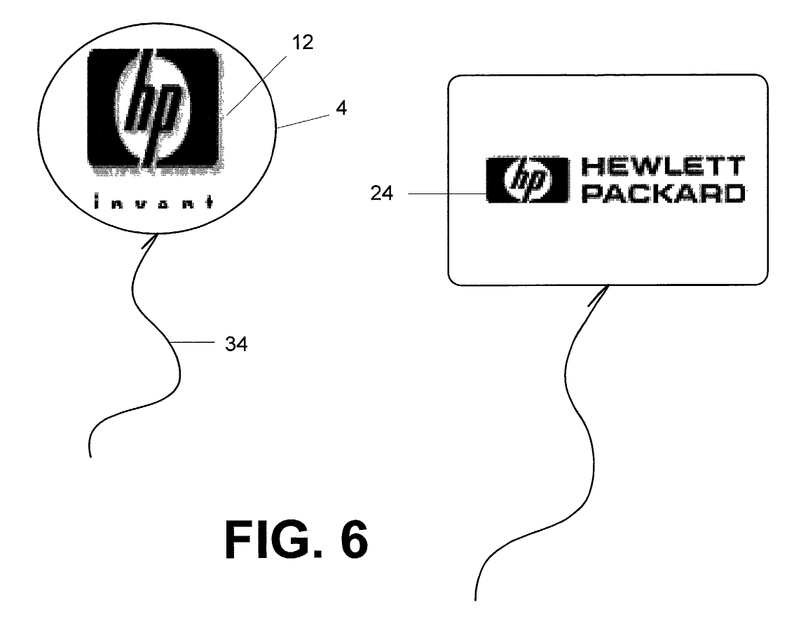

FIG. 6 illustrates two balloons on which a customized logo (e.g., 12 or 24) has been printed using the principles of the present invention. As discussed above, the design possibilities for imprinting on a foil, e.g., Mylar™, or other printable balloon (4) are not limited. If desired, a string (34), ribbon or other material may be tied to the balloon (4).

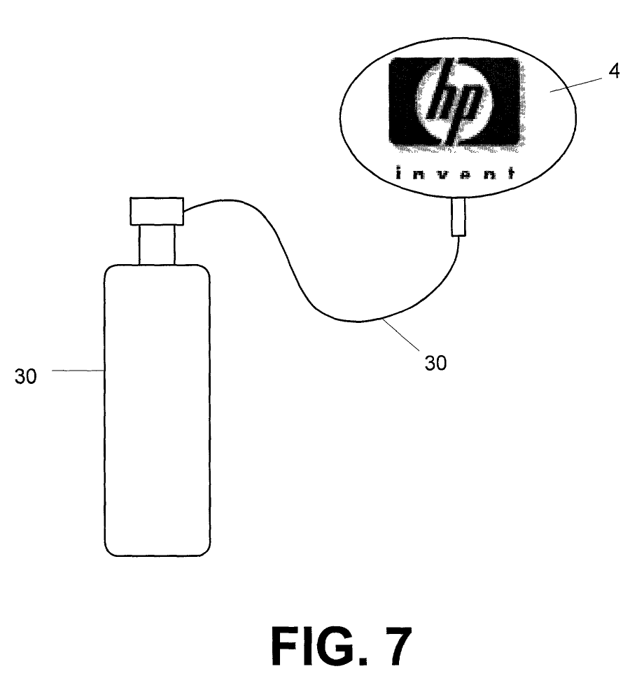

After a balloon (4) has received a printed image, e.g., logo (12), it may be also be inflated. For example, as shown in FIG. 7, a printed balloon (4) may be connected to a helium tank (30) having a hose (32) extending to the balloon (4). Other filling materials such as air, inert gases, or other gases may also be introduced into the balloon (4) as desired.

The preceding description has been presented only to illustrate and describe the invention. It is not intended to be exhaustive or to limit the invention to any precise form disclosed. Many modifications and variations are possible in light of the above teaching.

The preferred embodiment was chosen and described in order to best explain the principles of the invention and its practical application. The preceding description is intended to enable others skilled in the art to best utilize the invention in various embodiments and with various modifications as are suited to the particular use contemplated. It is intended that the scope of the invention be defined by the following claims.

What is claimed is:

1. A method of producing a balloon with a design thereon, comprising printing said design on said balloon with an inkjet printer.

2. The method of claim 1, further comprising supporting said balloon on a frame during said printing of said design.

3. The method of claim 1, wherein said printing further comprises passing said balloon through a high-speed inkjet printer, where said high-speed inkjet printer feeds said balloon through a straight print medium transport path.

4. The method of claim 1, further comprising selecting a foil balloon for said printing.

5. The method of claim 4, further comprising selecting a Mylar™ balloon as said foil balloon.

6. The method of claim 1, further comprising inflating the balloon after said printing.

7. The method of claim 1, wherein said printing further comprises printing said design in color.

8. The method of claim 1, further comprising printing on a balloon which has a width greater than eight inches.

9. A method of personalizing a balloon comprising:
loading a balloon into a inkjet printer;
sending data defining an image to said printer; and
printing said image onto said balloon as said balloon passes through said inkjet printer.

10. The method of claim 9, further comprising the step of inflating the balloon.

11. The method of claim 9, wherein said loading a balloon into said inkjet printer further comprises arranging said balloon on a frame and loading said balloon mounted on said frame into said inkjet printer.

12. The method of claim 11, further comprising making said frame of paper, cardstock, vinyl, or plastic.

13. The method of claim 9, further comprising providing a Mylar™ balloon as said balloon.

14. The method of claim 9, further comprising passing said balloon through said inkjet printer along a straight transport path.

15. The method of claim 9, wherein said image comprises text, graphics, or a combination of text and graphics.

16. A balloon printing apparatus comprising:
a frame for holding a balloon and supporting said balloon during passage through an inkjet printer;
a balloon disposed on said frame; and
an inkjet printer for receiving said balloon mounted on said frame and printing an image on said balloon.

17. The balloon printing apparatus of claim 16, wherein said balloon is a foil balloon comprising a polyester film.

18. The balloon printing apparatus of claim 17, wherein said polyester film comprises Mylar™.

19. The balloon printing apparatus of claim 16, wherein said inkjet printer comprises a color inkjet printer.

20. The balloon printing apparatus of claim 16, wherein said inkjet printer comprises a straight transport path along which said frame and balloon pass.

21. The balloon printing apparatus of claim 16, wherein the frame comprises paper.

22. The balloon printing apparatus of claim 16, wherein the frame comprises cardstock.

23. The balloon printing apparatus of claim 16, wherein the frame comprises plastic.

24. The balloon printing apparatus of claim 16, wherein the plastic frame comprises vinyl.

25. The balloon printing apparatus of claim 16, wherein the plastic frame comprises a transparency.
